(19) United States
(12) Patent Application Publication
(10) Pub. No.: US 2026/0366659 A1
(43) Pub. Date: Nov. 19, 2026

(54) Connector Assembly and Connecting Method

(71) Applicant: Illinois Tool Works Inc., Glenview, IL (US)

(72) Inventor: Cong Cao, Shanghai (CN)

(21) Appl. No.: 19/676,664

(22) Filed: May 13, 2026

(30) Foreign Application Priority Data
May 15, 2025 (CN) 202510629230.2

(51) Int. Cl. F16L 37/086

(52) U.S. Cl. CPC F16L 37/086; F16L 2201/10

(57) ABSTRACT

A connector assembly for a hose comprises an inner connector member and an outer connector member defining a longitudinal axis. The inner connector member includes a resilient latching arm that extends radially outward and downstream from an outer surface along an installation direction parallel to the longitudinal axis. The outer connector member includes first and second limiting surfaces that are perpendicular to the longitudinal axis and circumferentially aligned. The second limiting surface is positioned upstream of the first limiting surface at a predetermined distance along the installation direction. During assembly, the resilient latching arm engages the limiting surfaces to provide secure axial retention of the hose connection.

### RELATED APPLICATIONS

The present application claims the benefit of Chinese Patent Application No. 202510629230.2, filed May 15, 2025, titled “Connector Assembly and Connecting Method,” the contents of which are hereby incorporated by reference.

### BACKGROUND

The disclosure relates to a connector assembly and a connection method, and more specifically, the disclosure relates to a connector assembly for a hose and a method of connecting a hose using the connector assembly.

Connector assemblies are widely used in many fields, such as automotive, energy storage, etc. Connector assemblies are used to provide fluid connections between two pipes directly or between a pipe and another component. In existing connector assemblies, after connecting the pipes, additional fastening means are typically required to secure the connector assemblies, which increases cost and complexity of the connector assemblies. For example, some hoses (such as polydodecylamide (PA12) bellows) use connector assemblies provided with multiple barb elements (also known as pine needle heads) arranged along a longitudinal axis to hold the hose in place. However, this requires to press the hose with significant force by special equipment. Furthermore, some hoses (such as rubber pipes) use connector assemblies provided with a pagoda head to connect the hoses. However, the pagoda head must precisely match with the hose's inner diameter; otherwise, connection leaks or hose detachment may occur, which increase manufacturing costs. Additionally, pagoda head connector assemblies need to use means such as flange clamps or bolts etc. to clamp the hose.

Therefore, there is a need for a connector assembly and a method for connecting a hose in a quick, simple, and reliable way without use of special tools.

### SUMMARY

The present disclosure relates generally to a connector assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a schematic exploded view of an exemplary connector assembly according to an embodiment of the disclosure.

FIG. 2 is a schematic perspective view of an inner connector member of the exemplary connector assembly according to the embodiment of the disclosure.

FIG. 3 is a schematic front view of the inner connector member of the exemplary connector assembly according to the embodiment of the disclosure.

FIG. 4 is a schematic side view of the inner connector member of the exemplary connector assembly according to the embodiment of the disclosure.

FIG. 5 is a schematic perspective view of an outer connector member of the exemplary connector assembly according to the embodiment of the disclosure.

FIG. 6 is another schematic perspective view of the outer connector member of the exemplary connector assembly according to the embodiment of the disclosure.

FIG. 7 is a schematic front view of the exemplary connector assembly according to the embodiment of the disclosure.

FIG. 8 is a schematic top view of the exemplary connector assembly according to the embodiment of the disclosure.

FIG. 9 is a schematic sectional view of the exemplary connector assembly according to the embodiment of the disclosure, taken along section line A-A of FIG. 7.

FIG. 10 is a schematic sectional view of the exemplary connector assembly according to the embodiment of the disclosure, taken along section line B-B of FIG. 8, wherein the outer connector member is in an installation-complete position relative to the inner connector member.

FIG. 11 is a schematic enlarged sectional view of a portion defined by circle C of FIG. 10.

FIG. 12 is a schematic sectional view similar to FIG. 10, wherein the outer connector member is in a pre-installation position relative to the inner connector member.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

As used herein, the phrase “at least one of” as used in the disclosure means “one or more” of a desired choice. For one example, the phrase “at least one of” as used in the disclosure means “only one single choice” or “both of two choices” if the number of its choices is two. For another example, the phrase “at least one of” as used in the disclosure means “only one single choice” or “any combination of equal to or more than two choices” if the number of its choices is equal to or more than three. Also, the term “and/or” as used in the disclosure means “either one or both of”. For instance, the phrase “at least one of A and B” encompasses (1) A alone, (2) B alone, and (3) both A and B. The phrase “at least one of A, B, and C” encompasses (1) A alone, (2) B alone, (3) C alone, (4) both A and B, (5) both B and C, (6) both A and C, and (7) all A, B, and C. In other words, the phrase “at least one of A and B” does not mean “at least one of A and at least one of B” in the disclosure.

The disclosure aims to provide a connector assembly and a method for connecting a hose in a quick, simple, and reliable way without use of special tools.

In one aspect, a connector assembly for a hose is provided, the connector assembly defines a longitudinal axis, and comprises: an inner connector member comprising a resilient latching arm extending radially outward downstream from an outer surface of the inner connector member along an installation direction parallel to the longitudinal axis; and an outer connector member. The outer connector member comprises a first limiting surface and a second limiting surface, which are both perpendicular to the longitudinal axis and aligned in the circumferential direction, the second limiting surface being located at a predetermined distance upstream of the first limiting surface with respect to the installation direction. The outer connector member is configured to be movable the predetermined distance relative to the inner connector member along the installation direction from a pre-installation position to an installation-complete position, in the pre-installation position, a free end surface of the resilient latching arm abuts against the first limiting surface; in the installation-complete position, the free end surface of the resilient latching arm abuts against the second limiting surface.

The inner connector member may comprise a first end configured to receive the hose and a second end opposite to the first end, and may comprise: an inner tubular body extending axially along the longitudinal axis and defining an internal axial through-hole; and a barb element adjacent to the first end of the inner connector member and protruding radially outward around an outer surface of the inner tubular body, an outer diameter of the barb element increasing along the installation direction to define a tapered outer surface.

The outer connector member may comprise a first end configured to receive the hose and an opposing second end, and may comprise: a first tubular body adjacent to the first end of the outer connector member and extending axially along the longitudinal axis; a second tubular body adjacent to the second end of the outer connector member and extending axially along the longitudinal axis, and having an inner diameter larger than that of the first tubular body; and a transition portion located between the first tubular body and the second tubular body, the transition portion defining a tapered inner surface cooperating with the tapered outer surface to clamp the hose.

The inner connector member may further comprise a stop element disposed downstream of the barb element along the installation direction and protruding radially outward from the outer surface of the inner tubular body, and the outer connector member may further comprise an observation window, the second limiting surface is defined at a downstream side of the observation window along the installation direction, when the outer connector member is in the pre-installation position relative to the inner connector member, the stop element is located within the observation window to allow to observe whether the hose abuts against the stop element through the observation window.

The stop element and the barb element may be axially spaced apart along the longitudinal axis and a circumferential retaining groove is defined between the stop element and the barb element, the circumferential retaining groove being configured to contact with an end of the hose when the hose abuts against the stop element.

When the hose abuts against the stop element, the stop element and the barb element contact respectively with an outer edge and an inner edge of an end surface of the hose to prevent the hose from sliding backward with respect to the installation direction.

The inner connector member may further comprise a first positioning element and the outer connector member may further comprise a second positioning element, the first positioning element and the second positioning element being aligned in a circumferential direction and configured to cooperate to position the outer connector member relative to the inner connector member in the circumferential direction.

The first positioning element may protrude radially outward from the outer surface of the inner connector member and extends axially from the second end of the inner connector member, and the second positioning element may be recessed from an inner surface of the second tubular body of the outer connector member, when the connector assembly is in the installation-complete position, the second positioning element has the same axial extension range as the first positioning element.

The resilient latching arm and observation window may be both two in number and are both disposed diametrically opposite with regard to the longitudinal axis.

The first positioning element and the second positioning element may be both two in number and are both disposed diametrically opposite with regard to the longitudinal axis.

The resilient latching arm and the first positioning element may be alternately disposed in the circumferential direction.

The inner connector member may further comprise a hose guide portion located at the first end of the inner connector member and configured to facilitate the hose to be fitted outside of the inner connector member along an outer surface of the hose guide portion.

The outer connector member may further comprise a manipulation area disposed on the outer surface of the outer connector member and configured to facilitate manipulation of the outer connector member.

The manipulation area may comprise a friction-increasing structure.

The manipulation area may be disposed at the same position as the second positioning element.

The inner connector member may further comprise a circumferential sealing groove extending circumferentially around the outer surface of the inner connector member, the circumferential sealing groove being located upstream of the barb element along the installation direction, and the connector assembly further comprises a seal received within the circumferential sealing groove configured to seal between the hose and the inner connector member.

In another respect, a method of connecting a hose using the connector assembly as described above is provided, and comprises: fitting a second end of the outer connector member outside of a first end of the inner connector member, and moving the outer connector member relative to the inner connector member along the installation direction to the pre-installation position; fitting the hose outside of the first end of the inner connector member and moving the hose across a barb element along the installation direction until an end surface of the hose abuts against a stop element; and moving the outer connector member from the pre-installation position to the installation-complete position relative to the inner connector member along the installation direction.

The connector assembly according to this disclosure has a simple structure and can quickly move the outer connector member relative to the inner connector member along the installation direction to the pre-installation position without additional special tools. Therefore, it saves the cost and complexity of the connector assembly and also reduces the time and labor required for connecting the hose.

The connector assembly according to this disclosure may be provided with a stop element and a circumferential retaining groove, when the hose abuts against the stop element, the stop element and the circumferential retaining groove contact respectively with the outer edge and inner edge of the end surface of the hose to prevent the hose from sliding backward with respect to the installation direction, which can more reliably hold the hose. Furthermore, the stop element is located within the observation window, which allows to observe whether the hose is installed in place to ensure that the hose is reliably connected to the connector assembly.

The connector assembly according to this disclosure may be provided with two first positioning elements, two second positioning elements, and two resilient latching arms. The two resilient latching arms and the two first/second positioning elements may be alternately disposed in the circumferential direction. This may dispose the resilient latching arms and the first positioning elements at substantially the same axial position of the inner connector member, thereby reducing an axial length of the inner connector member and further saving the cost of the connector assembly.

The outer connector member of the connector assembly according to this disclosure may be provided with a manipulation area, which may be disposed at the same position as the second positioning element, thereby reducing the axial length of the outer connector member and further saving the cost of the connector assembly.

Further areas of applicability of the disclosure will become apparent from the detailed description, the claims and the drawings. The detailed description and specific examples are intended for purposes of illustration only and are not intended to limit the scope of the disclosure.

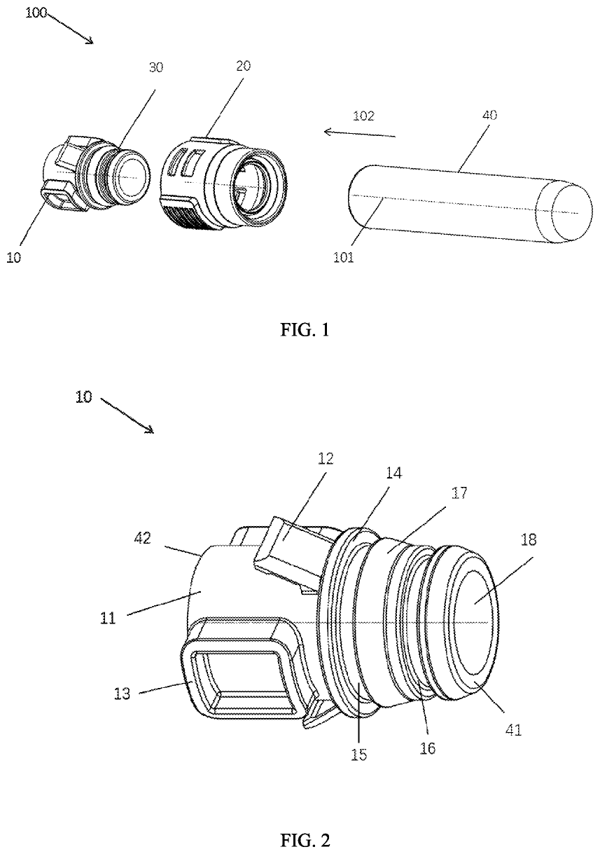

Referring now to the drawings, wherein like reference numerals represent like features throughout several views. FIG. 1 is a schematic exploded view of an exemplary connector assembly 100 according to an embodiment of the disclosure. The connector assembly 100 defines a longitudinal axis 101 and an installation direction 102 parallel to the longitudinal axis 101. As used herein, the term “axial” refers to a direction parallel to the longitudinal axis 101, and the term “circumferential” refers to a circumferential direction around the longitudinal axis 101. According to one example, the connector assembly 100 comprises an inner connector member 10, an outer connector member 20, and a seal 30. It should be understood that the connector assembly 100 may not comprise the seal 30 without departing from the scope of the disclosure. The connector assembly 100 is used to connect a hose 40. As used herein, the term “hose” refers to a flexible pipe with pipe walls deformable.

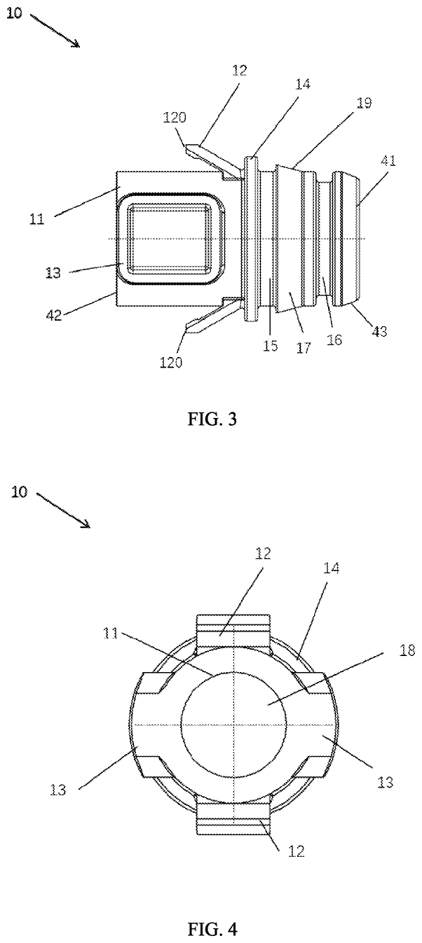

FIG. 2 is a schematic perspective view of the inner connector member 10 of the exemplary connector assembly 100 according to the embodiment of the disclosure. FIG. 3 is a schematic front view of the inner connector member 10 of the exemplary connector assembly 100 according to the embodiment of the disclosure. FIG. 4 is a schematic side view of the inner connector member 10 of the exemplary connector assembly 100 according to the embodiment of the disclosure.

The inner connector member 10 comprises a first end 41 configured to receive the hose 40 and a second end 42 opposite to the first end 41. The first end 41 of the inner connector member 10 is located upstream of the second end 42 of the inner connector member 10 with respect to the installation direction 102 and is closer to the hose 40, and can therefore also be referred to as a proximal end. Correspondingly, the second end 42 of the inner connector member 10 can also be referred to as a distal end.

According to one example, the inner connector member 10 comprises an inner tubular body 11 and a barb element 17. The inner tubular body 11 extends axially along the longitudinal axis 101 and defines an internal axial through-hole 18. The barb element 17 is adjacent to the first end 41 of the inner connector member 10 and projects radially outward around an outer surface of the inner tubular body 11. An outer diameter of the barb element 17 increases along the installation direction 102 to define a tapered outer surface 19. According to one example, the inner connector member 10 comprises one barb element 17. It should be understood that the inner connector member 10 may comprise any other suitable number of barb elements 17, such as two, three, etc., without departing from the scope of this disclosure. According to one example, the diameter of a downstream end of the tapered outer surface 19 with respect to the installation direction 102 may be 5% to 30 % larger than the diameter of an upstream end of the tapered outer surface 19 with respect to the installation direction 102. It should be understood that the diameter of the downstream end of the tapered outer surface 19 with respect to the installation direction 102 may be larger by any other suitable value than the diameter of the upstream end of the tapered outer surface 19 with respect to the installation direction 102 without departing from the scope of this disclosure.

According to one example, the inner connector member 10 may further comprise a resilient latching arm 12 adjacent to the second end 42 of the inner connector member 10 and extending radially outward downstream from the outer surface of the inner tubular body 11 along the installation direction 102. According to one example, the inner connector member 10 comprises two resilient latching arms 12 disposed diametrically opposite with respect to the longitudinal axis 101. It should be understood that the inner connector member 10 may comprise any other suitable number of resilient latching arms 12, such as one, three, etc., without departing from the scope of this disclosure.

According to one example, the inner connector member 10 may further comprise a stop element 14 disposed downstream of the barb element 17 along the installation direction 102 and projecting radially outward from the outer surface of the inner tubular body 11. According to one example, the stop element 14 is a circumferential flange. It should be understood that the stop element 14 may take any other suitable form, such as a plurality of radially protrusions distributed circumferencially around the circumference of the inner connector member 10, without departing from the scope of this disclosure.

According to one example, the stop element 14 and the barb element 17 are axially spaced apart along the longitudinal axis 101, and a circumferential retaining groove 15 is defined between the stop element 14 and the barb element 17. The circumferential retaining groove 15 is configured to contact with an end of the hose 40 when the hose 40 abuts against the stop element 14. When the hose 40 is inserted into place, the outer edge of the end surface of the hose 40 contacts with the stop element 14, and the inner edge of the end surface of the hose 40 contacts with the circumferential retaining groove 15 to prevent the hose 40 from sliding backward with respect to the installation direction 102, which facilitates to hold the hose 40 as the outer connector member 20 moves from the pre-installation position to the installation-complete position.

According to one example, the inner connector member 10 may further comprise a first positioning element 13, the first positioning element 13 and a second positioning element 28 of the outer connector member 20 being aligned in the circumferential direction and configured to cooperate to position the outer connector member 20 relative to the inner connector member 10 in the circumferential direction. According to one example, the first positioning element 13 projects radially outward from the outer surface of the inner connector member 10 and extends axially from the second end 42 of the inner connector member 10. It should be understood that the first positioning element 13 may be radially inward recessed from the outer surface of the inner connector member 10, in this regard, the second positioning element 28 of the outer connector member 20 projects radially inward from the inner surface of the outer connector member 20, without departing from the scope of this disclosure. According to one example, the inner connector member 10 comprises two first positioning elements 13 disposed diametrically opposite with respect to the longitudinal axis 101. It should be understood that the inner connector member 10 may comprise any other suitable number of first positioning elements 13, such as one, three, etc., without departing from the scope of this disclosure. According to one example, the resilient latching arm 12 and the first positioning element 13 are disposed staggered or alternately in the circumferential direction, which may dispose the resilient latching arm 12 and the first positioning element 13 at substantially the same axial position of the inner connector member 10, thereby reducing the axial length of the inner connector member 10 and further saving the cost of the connector assembly 100.

According to one example, the inner connector member 10 may further comprise a hose guide portion 43. The hose guide portion 43 is located at the first end 41 of the inner connector member 10 and configured to facilitate to insert or fit the hose 40 outside of the inner connector member (10) along the outer surface of the hose guide portion 43. According to one example, the hose guide portion 43 is a chamfer. It should be understood that the hose guide portion 43 may take any other suitable form, such as a tapered portion, without departing from the scope of this disclosure.

According to one example, the inner connector member 10 may further comprise a circumferential sealing groove 16 extending circumferentially around the outer surface of the inner connector member 10, the circumferential sealing groove 16 being located upstream of the barb element 17 along the installation direction 102. The connector assembly 100 also comprises a seal 30 received within the circumferential sealing groove 16 configured to seal between the hose 40 and the inner connector member 10. It should be understood that the inner connector member 10 may not comprise the circumferential sealing groove 16 without departing from the scope of this disclosure.

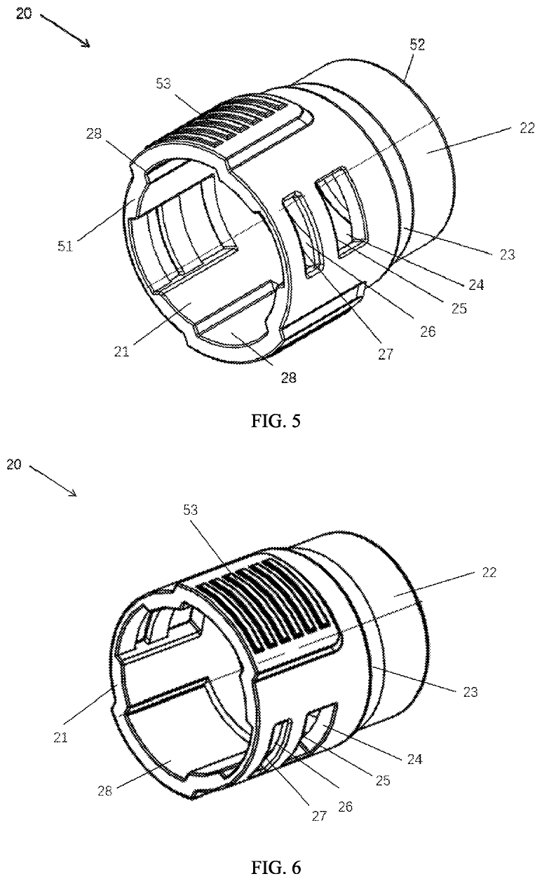

FIG. 5 is a schematic perspective view of the outer connector member 20 of the exemplary connector assembly 100 according to the embodiment of the disclosure. FIG. 6 is another schematic perspective view of the outer connector member 20 of the exemplary connector assembly 100 according to the embodiment of the disclosure. The outer connector member 20 comprises a first end 52 configured to receive the hose 40 and an opposing second end 51. According to one example, the outer connector member 20 comprises: a first tubular body 22 adjacent to the first end 52 of the outer connector member 20 and extending axially along the longitudinal axis 101; a second tubular body 21 adjacent to the second end 51 of the outer connector member 20 and extending axially along the longitudinal axis 101, and having a inner diameter larger than that of the first tubular body 22; and a transition portion 23 located between the first tubular body 22 and the second tubular body 21, the transition portion 23 defining a tapered inner surface 29 that cooperates with the tapered outer surface 19 to clamp the hose 40. An outer diameter of the inner tubular body 11 of the inner connector member 10 should be slightly smaller than the inner diameter of the hose 40, and a radial distance between the inner surface of the first tubular body 22 of the outer connector member 20 and the outer surface of the inner tubular body 11 of the inner connector member 10 should be greater than a wall thickness of the hose 40. According to one example, the tapered outer surface 19 and the tapered inner surface 29 are tapered surfaces with the same slope/taper with respect to the longitudinal axis 101 in a longitudinal section of the connector assembly 100. It should be understood that the tapered outer surface 19 and the tapered inner surface 29 may not be smooth surfaces, and comprises, for example, serrations or multiple protrusions to increase friction force with the hose 40.

According to one example, the second tubular body 21 comprises a first limiting surface 27 and a second limiting surface 25, which are both perpendicular to the longitudinal axis 101 and aligned in the circumferential direction. The second limiting surface 25 is located at a predetermined distance upstream of the first limiting surface 27 with respect to the installation direction 102. The outer connector member 20 may further comprise an observation window 24, with the second limiting surface 25 defined at a downstream side of the observation window 24 along the installation direction 102. The outer connector member 20 may also comprise an additional window 26, with the first limiting surface 27 defined at a downstream side of the additional window 26 along the installation direction 102. It should be understood that the outer connector member 20 may also not comprise the additional window 26. When the additional window 26 is included, the number of the additional window 26 and the number of the observation window 24 are the same as the number of the elastic latch arm 12, and circumferential positions of the additional window 26 and the observation window 24 are aligned with circumferential positions of the elastic latch arm 12.

The outer connector member 20 is configured to be movable the predetermined distance relative to the inner connector member 10 along the installation direction 102 from a pre-installation position to an installation-complete position. In the pre-installation position, an free end surface 120 of the resilient latching arm 12 abuts against the first limiting surface 27, and a distance between the tapered outer surface 19 and the tapered inner surface 29 is greater than the wall thickness of the hose 40 to allow the hose 40 to move axially across the barb element 17 from the first end 41 of the inner connector member 10 along the installation direction 102; in the installation-complete position, the free end surface 120 of the resilient latching arm 12 abuts against the second limiting surface 25, and the distance between the tapered outer surface 19 and the tapered inner surface 29 is less than the wall thickness of the hose 40 to clamp the hose 40. When the outer connector member 20 is in the pre-installation position relative to the inner connector member 10, the stop element 14 is located within the observation window 24 to allow to observe whether the hose 40 abuts against the stop element 14 through the observation window 24.

According to one example, the outer connector member 20 may further comprise a second positioning element 28. The first positioning element 13 and the second positioning element 28 are aligned in the circumferential direction and configured to cooperate to position the outer connector member 20 relative to the inner connector member 10 in the circumferential direction. According to one example, the second positioning element 28 is recessed from the inner surface of the second tubular body 21 of the outer connector member 20.

According to one example, the outer connector member 20 may further comprise a manipulation area 53. The manipulation area 53 is disposed on the outer surface of the outer connector member 20 and configured to facilitate manipulation of the outer connector member 20. According to one example, the manipulation area 53 may comprise a friction-increasing structure, such as an embossed structure or textured structure. It should be understood that the manipulation area 53 may comprise any other suitable structure without departing from the scope of this disclosure. According to one example, the manipulation area 53 is disposed at the same position as the second positioning element 28, thereby reducing the axial length of the outer connector member 20 and further saving the cost of the connector assembly 100.

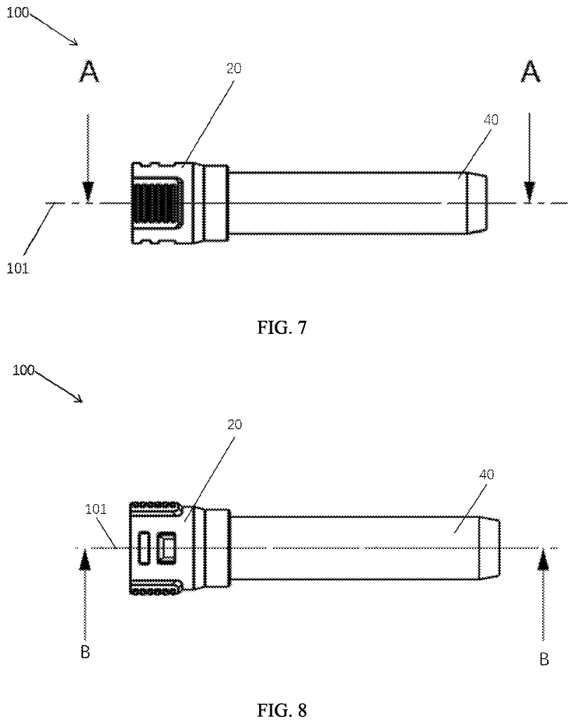

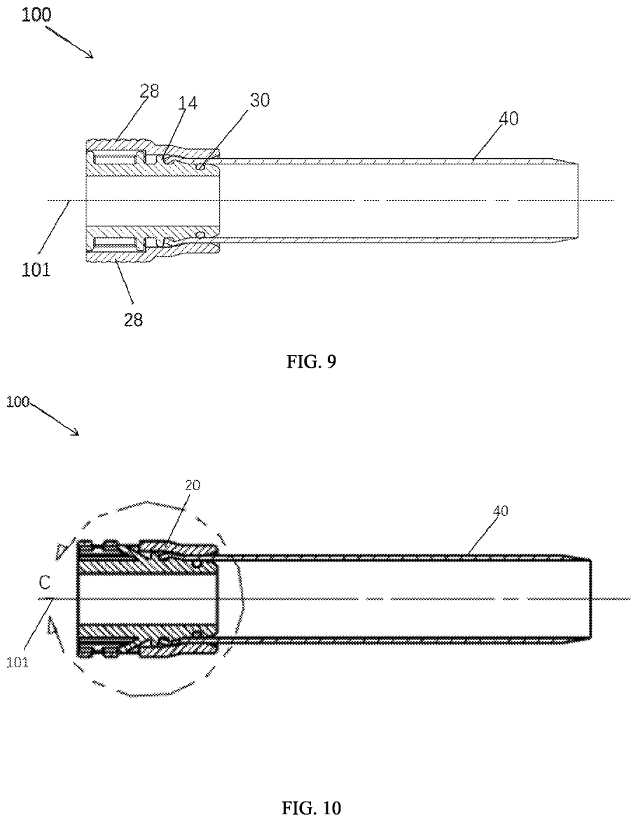

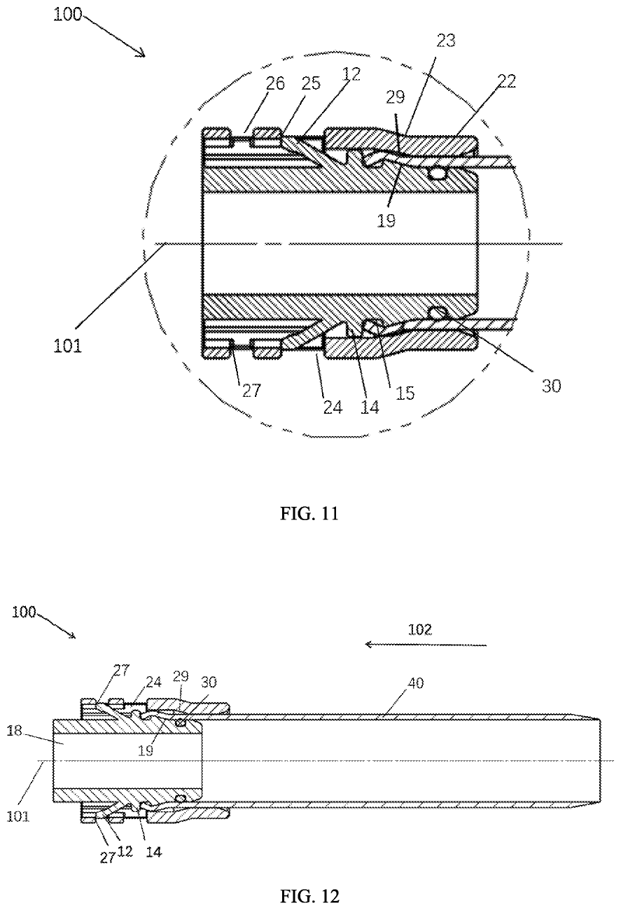

FIG. 7 is a schematic front view of the exemplary connector assembly 100 according to the embodiment of the disclosure. FIG. 8 is a schematic top view of the exemplary connector assembly 100 according to the embodiment of the disclosure. FIG. 9 is a schematic sectional view of the exemplary connector assembly 100 according to the embodiment of the disclosure taken along section line A-A of FIG. 7. FIG. 10 is a schematic sectional view of the exemplary connector assembly 100 according to the embodiment of the disclosure taken along section line B-B of FIG. 8, wherein the outer connector member 20 is in the installation-complete position relative to the inner connector member 10. FIG. 11 is a schematic enlarged sectional view of a portion defined by circle C of FIG. 10. FIG. 12 is a schematic sectional view similar to FIG. 10, wherein the outer connector member 20 is in the pre-installation position relative to the inner connector member 10.

A method of connecting a hose 40 using the connector assembly 100 according to claim 1 is described below in connection with the accompanying drawings. The method comprises: fitting the second end 51 of the outer connector member 20 outside of the first end 41 of the inner connector member 10, and moving the outer connector member 20 relative to the inner connector member 10 along the installation direction 102 to the pre-installation position. In the pre-installation position, the resilient snap arm 12 abuts against the first limiting surface 27, and the distance between the tapered outer surface 19 and the tapered inner surface 29 is greater than the wall thickness of the hose 40 to allow the hose 40 to move axially across the barb element 17 from the first end 41 of the inner connector member 10 along the installation direction 102. Next, the method further comprises: fitting the hose 40 outside of the first end 41 of the inner connector member 10 and moving it along the installation direction 102 across the barb element 17 until the end surface of the hose 40 abuts against the stop element 14, as shown in FIG. 12. The method further comprises moving the outer connector member 20 relative to the inner connector member 10 along the installation direction 102 from the pre-installation position to the installation-complete position, as shown in FIG. 10. In the installation-complete position, the resilient latching arm 12 abuts against the second limiting surface 25, and the distance between the tapered outer surface 19 and the tapered inner surface 29 is less than the wall thickness of the hose 40 to clamp the hose 40.

The connector assembly 100 according to this disclosure has a simple structure and can quickly move the outer connector member 20 relative to the inner connector member 10 along the installation direction to the pre-installation position without additional special tools. Therefore, it saves the cost and complexity of the connector assembly 100 and also reduces the time and labor required for connecting the hose 40.

The foregoing description is merely illustrative in nature and is in no way intended to limit the disclosure, its application, or uses. The broad teachings of the disclosure can be implemented in a variety of forms. Therefore, while the disclosure comprises particular examples, the true scope of the disclosure should not be so limited since other modifications will become apparent upon a study of the drawings, the specification, and the following claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature. It should be understood that one or more steps within a method may be executed in different order (or concurrently) without altering the principles of the disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of the disclosure.

What is claimed is:

1. A connector assembly (100) for a hose (40), the connector assembly (100) defining a longitudinal axis (101), the connector assembly (100) comprising:
an inner connector member (10) comprising a resilient latching arm (12) extending radially outward downstream from an outer surface of the inner connector member (10) along an installation direction (102) parallel to the longitudinal axis (101); and
an outer connector member (20) comprising a first limiting surface (27) and a second limiting surface (25), which are both perpendicular to the longitudinal axis (101) and aligned in a circumferential direction, the second limiting surface (25) being located at a predetermined distance upstream of the first limiting surface (27) with respect to the installation direction (102);
wherein the outer connector member (20) is configured to be movable the predetermined distance relative to the inner connector member (10) along the installation direction (102) from a pre-installation position to an installation-complete position, wherein in the pre-installation position, a free end surface (120) of the resilient latching arm (12) abuts against the first limiting surface (27), and wherein in the installation-complete position, the free end surface (120) of the resilient latching arm (12) abuts against the second limiting surface (25).

2. The connector assembly (100) of claim 1, wherein the inner connector member (10) comprises a first end (41) configured to receive the hose (40) and a second end opposite to the first end (41), the inner connector member (10) comprising:
an inner tubular body (11) extending axially along the longitudinal axis (101) and defining an internal axial through-hole (18); and
a barb element (17) adjacent to the first end (41) of the inner connector member (10) and protruding radially outward around an outer surface of the inner tubular body (11), an outer diameter of the barb element (17) increasing along the installation direction (102) to define a tapered outer surface (19); and
wherein the outer connector member (20) comprises a first end (52) configured to receive the hose (40) and an opposing second end (51), the outer connector member (20) comprising:
a first tubular body (22) adjacent to the first end (52) of the outer connector member (20) and extending axially along the longitudinal axis (101);
a second tubular body (21) adjacent to the second end (51) of the outer connector member (20) and extending axially along the longitudinal axis (101), and having an inner diameter larger than that of the first tubular body (22); and
a transition portion (23) located between the first tubular body (22) and the second tubular body (21), the transition portion (23) defining a tapered inner surface (29) cooperating with the tapered outer surface (19) to clamp the hose (40).

3. The connector assembly (100) of claim 2, wherein the inner connector member (10) further comprises a stop element (14) disposed downstream of the barb element (17) along the installation direction (102) and protruding radially outward from the outer surface of the inner tubular body (11), and wherein the outer connector member (20) further comprises an observation window (24), the second limiting surface (25) being defined at a downstream side of the observation window (24) along the installation direction (102), wherein when the outer connector member (20) is in the pre-installation position relative to the inner connector member (10), the stop element (14) is located within the observation window (24) to allow observation of whether the hose (40) abuts against the stop element (14) through the observation window (24).

4. The connector assembly (100) of claim 3, wherein the stop element (14) and the barb element (17) are axially spaced apart along the longitudinal axis (101) and a circumferential retaining groove (15) is defined between the stop element (14) and the barb element (17), the circumferential retaining groove (15) being configured to receive an end of the hose (40) when the hose (40) abuts against the stop element (14).

5. The connector assembly (100) of claim 4, wherein when the hose (40) abuts against the stop element (14), the stop element (14) and the barb element (17) contact respectively with an outer edge and an inner edge of an end surface of the hose (40) to prevent the hose (40) from sliding backward with respect to the installation direction (102).

6. The connector assembly (100) of claim 4, wherein the inner connector member (10) further comprises a first positioning element (13) and the outer connector member (20) further comprises a second positioning element (28), the first positioning element (13) and the second positioning element (28) being aligned in a circumferential direction and configured to cooperate to position the outer connector member (20) relative to the inner connector member (10) in the circumferential direction.

7. The connector assembly (100) of claim 6, wherein the first positioning element (13) protrudes radially outward from the outer surface of the inner connector member (10) and extends axially from the second end (42) of the inner connector member (10), and wherein the second positioning element (28) is recessed from an inner surface of the second tubular body (21) of the outer connector member (20), wherein when the connector assembly (100) is in the installation-complete position, the second tubular body (21) has the same axial extension range as the first positioning element (13).

8. The connector assembly (100) of claim 6, wherein the resilient latching arm (12) and the observation window (24) are both two in number and are both disposed diametrically opposite with regard to the longitudinal axis (101).

9. The connector assembly (100) of claim 8, wherein the first positioning element (13) and the second positioning element (28) are both two in number and are both disposed diametrically opposite with regard to the longitudinal axis (101).

10. The connector assembly (100) of claim 9, wherein the resilient latching arm (12) and the first positioning element (13) are alternately disposed in the circumferential direction.

11. The connector assembly (100) of claim 1, wherein the inner connector member (10) further comprises a hose guide portion (43) located at the first end (41) of the inner connector member (10) and configured to facilitate fitting of the hose (40) outside of the inner connector member (10) along an outer surface of the hose guide portion (43).

12. The connector assembly (100) of claim 1, wherein the outer connector member (20) further comprises a manipulation area (53) disposed on an outer surface of the outer connector member (20) and configured to facilitate manipulation of the outer connector member (20).

13. The connector assembly (100) of claim 12, wherein the manipulation area (53) comprises a friction-increasing structure.

14. The connector assembly (100) of claim 12, wherein the inner connector member (10) further comprises a first positioning element (13) and the outer connector member (20) further comprises a second positioning element (28), the first positioning element (13) and the second positioning element (28) being aligned in a circumferential direction and configured to cooperate to position the outer connector member (20) relative to the inner connector member (10) in the circumferential direction, and wherein the manipulation area (53) is disposed at the same position as the second positioning element (28).

15. The connector assembly (100) of claim 1, wherein the inner connector member (10) further comprises a circumferential sealing groove (16) extending circumferentially around the outer surface of the inner connector member (10), the circumferential sealing groove (16) being located upstream of the barb element (17) along the installation direction (102), and wherein the connector assembly (100) further comprises a seal (30) received within the circumferential sealing groove (16) and configured to seal between the hose (40) and the inner connector member (10).

16. A method of connecting a hose using the connector assembly (100) of claim 1, the method comprising:
fitting a second end (51) of the outer connector member (20) outside of a first end (41) of the inner connector member (10), and moving the outer connector member (20) relative to the inner connector member (10) along the installation direction (102) to the pre-installation position;
fitting the hose (40) outside of the first end (41) of the inner connector member (10) and moving the hose (40) across a barb element (17) along the installation direction (102) until an end surface of the hose (40) abuts against a stop element (14); and
moving the outer connector member (20) from the pre-installation position to the installation-complete position relative to the inner connector member (10) along the installation direction (102).
